(19) United States
(12) Patent Application Publication
(10) Pub. No.: US 2002/0028596 A1
(43) Pub. Date: Mar. 7, 2002

(54) Mounting pin and mounting device

(75) Inventor: Koji Soejima, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/949,046

(22) Filed: Sep. 7, 2001

(30) Foreign Application Priority Data
Sep. 7, 2000 (JP) 271142/2000

(51) Int. Cl. H01R 13/62

(52) U.S. Cl. 439/357

(57) ABSTRACT

A mounting pin is formed at a pin position on a circuit board or LSI and adopted to set the circuit board or LSI in a mounted state through pin connection. The mounting pin includes a leg standing upright at the pin position, and a locking projection formed at a distal end of the leg to project in one direction and capable of locking with a locking projection of another mounting pin through pin connection. Mounting pins corresponding to each other are set in a pin-connected state by the locking projection when the circuit board and LSI are mounted. A method of manufacturing a mounting pin is also disclosed.

### BACKGROUND OF THE INVENTION

The present invention relates to a mounting pin and mounting device in a high-density mounted structure, with which a circuit element can be detachably mounted on a circuit board.

Conventionally, as shown in Japanese Patent Laid-Open No. 7-297197, a mounting device is known in which a semiconductor chip and package board, or semiconductor chips are electrically connected to each other by fitting pins.

FIG. 12 shows the pin structure of a conventional mounting device. As shown in FIG. 12, the conventional mounting device has a pair of contact pads 1 and 3 opposing each other, a male pin 2 formed on the contact pad 1, and a pair of female pins 4a and 4b formed on the contact pad 3 to oppose the male pin 2.

The male pin 2 has recesses 5 on the two sides of almost its intermediate portion. The female pins 4a and 4b have projections 6 formed at almost their intermediate portions to oppose each other. When the contact pads 1 and 3 move close to each other, the male pin 2 is inserted between the female pins 4a and 4b. At this time, the projections 6 mesh with the recesses 5 of the male pin 2, so the male pin 2 can be fitted between the female pins 4a and 4b.

The male pin 2 and female pins 4a and 4b are fabricated separately by forming a resist pattern corresponding to the male pin 2 or female pins 4a and 4b by the following method.

First, three resist layers comprised of two resist layers photosensitive to X-rays and a resist layer interposed between the two resist layers and photosensitive to ultraviolet rays are formed, and X-rays and ultraviolet rays selectively irradiate to photosensitize the three resist layers. After photosensitization, the resultant structure is developed to form a pattern, electroplating is performed to bury a metal material, and the resist is removed. Hence, the male pin 2 with the recesses 5 at its intermediate portion and the female pins 4a and 4b with the projections 6 at their intermediate portions can be respectively formed.

In this manner, conventionally, high-density mounting is realized by the male pin 2 with the recesses 5 and the pair of female pins 4a and 4b with the projections 6, and a pin structure that enables firm connection with a small contact area is obtained. Currently, however, higher-density mounting is demanded. In particular, a further reduction in the electrode area necessary for connection is sought for so the resultant structure is suitable for micro-connection.

More specifically, to cope with a multi-pin small-pitch structure along with an increase in packaging density, the connection area need be reduced more to form a structure suitable for a small pitch. In the pin structure of the conventional mounting device, however, to insert the male pin 2, the two female pins 4a and 4b must be formed on one electrode, and accordingly a larger area is needed. The resultant structure is not suitable for a small pitch. Also, since the recesses 5 must be formed on the male pin 2 and the projections 6 must be formed on the female pins 4a and 4b, the manufacturing process becomes inevitably complicated.

### SUMMARY OF THE INVENTION

It is an object of the present invention to provide a mounting pin and mounting device having a structure with a smaller connection area and thus suitable for a small pitch, so that a further increase in packaging density can be coped with.

It is another object of the present invention to provide a mounting pin and mounting device that can be manufactured with a simple process.

In order to achieve the above objects, according to the present invention, there is provided a mounting pin formed at a pin position on a mounting target and adopted to set the mounting target in a mounted state through pin connection, comprising a leg standing upright at the pin position, and a locking projection formed at a distal end of the leg to project in one direction and capable of locking with a locking projection of another mounting pin through pin connection, wherein the mounting pins corresponding to each other are set in a pin-connected state by the locking projections when each mounting target is mounted.

### BRIEF DESCRIPTION OF THE DRAWINGS

FIG. 1A is a perspective view of mounting pins according to an embodiment of the present invention;

FIG. 1B is a side view of the mounting pins;

FIGS. 2A to 2D are views showing mounting examples using the mounting pins shown in FIGS. 1A and 1B;

FIG. 3 is a view showing the connected state of the mounting pins of FIGS. 1A and 1B;

FIG. 4 is a sectional view showing the internal structure of a mounting pin of FIGS. 1A and 1B;

FIG. 5 is a perspective view showing another example of the mounting pin;

FIGS. 6A and 6F are views showing steps in a method of manufacturing the mounting pin of FIGS. 1A and 1B;

FIGS. 7A and 7B are views showing distances among the mounting pins of FIGS. 1A and 1B;

FIG. 8 is a flow chart showing a process for shipping completed module parts mounted by using the mounting pins shown in FIGS. 1A and 1B;

FIGS. 9A to 9F are plan views showing the first arrangement example of the mounting pins of FIGS. 1A and 1B;

FIGS. 10A to 10E are plan views showing the second arrangement example of the mounting pins of FIGS. 1A and 1B;

FIGS. 11A to 11F are plan views showing the third arrangement example of the mounting pins of FIGS. 1A and 1B; and

FIG. 12 is a side view showing the pin structure of a conventional mounting device.

### DESCRIPTION OF THE PREFERRED EMBODIMENTS

The present invention will be described in detail with reference to the accompanying drawings.

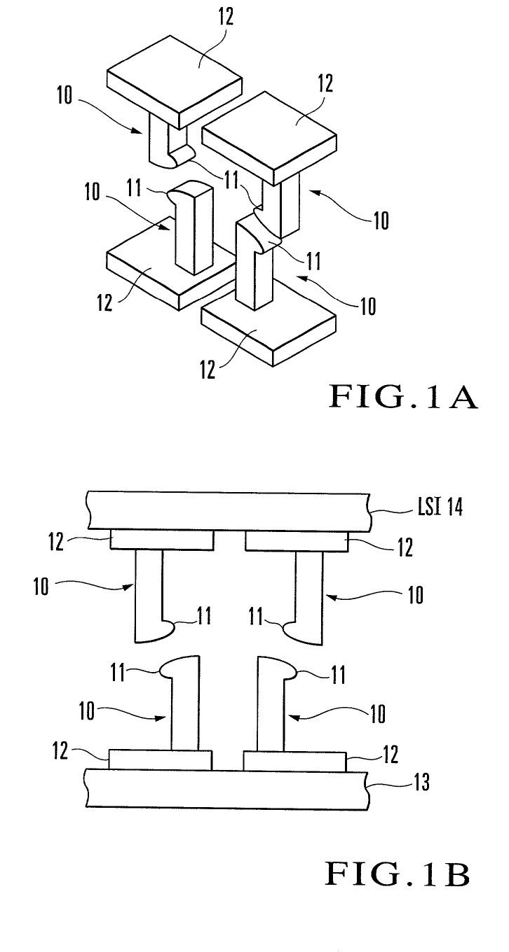

FIGS. 1A and 1B show mounting pins according to the first embodiment of the present invention. A conductive mounting pin 10 has a locking projection 11 as an extending portion at its distal end, as shown in FIG. 1A, and stands upright on an electrode pad 12 such that the locking projection 11 serves as the projecting end. Each of a circuit board 13, an LSI (Large Scale Integrated circuit) 14 as the mounting target of the circuit board 13, and the like has a plurality of electrode pads 12.

In a multi-pin, small-pitch, high-density mounted structure, the mounting pins 10 are formed on connection targets (the circuit board 13 and LSI 14) with their locking projections 11 opposing each other so that when the LSI 14 is mounted on the circuit board 13, the mounting pins 10 formed on the respective electrode pads 12 engage with each other in one-to-one correspondence.

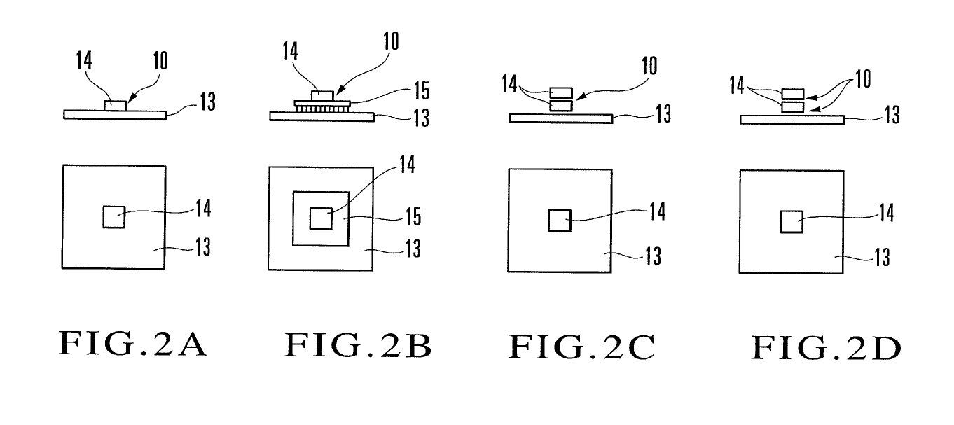

FIGS. 2A to 2D show the mounting operations when the mounting pins shown in FIGS. 1A and 1B are used. Each of FIGS. 2A to 2D show a side view on the upper side and a plan view on the lower side that form a pair. An interposer such as the LSI 14 or a package 15 is mounted on the circuit board 13 by using the mounting pins 10 (not shown), i.e., is physically and electrically connected.

As mounted examples, FIG. 2A shows a chip-on board in which an LSI 14 is mounted on a circuit board 13 by using mounting pins 10. Also, FIG. 2B shows mounting in which an LSI 14 is connected on a package 15, connected to a circuit board 13 by BGA (Ball Grid Array) or PGA (Pin Grid Array), by using mounting pins 10.

FIG. 2C shows LSI stack connection in which, on an LSI 14 connected to a circuit board 13 by BGA or PGA, another LSI 14 is further connected by using mounting pins 10. FIG. 2D shows LSI stack connection in which, on an LSI 14 connected to a circuit board 13 by using mounting pins 10, another LSI 14 is further connected by using other mounting pins 10.

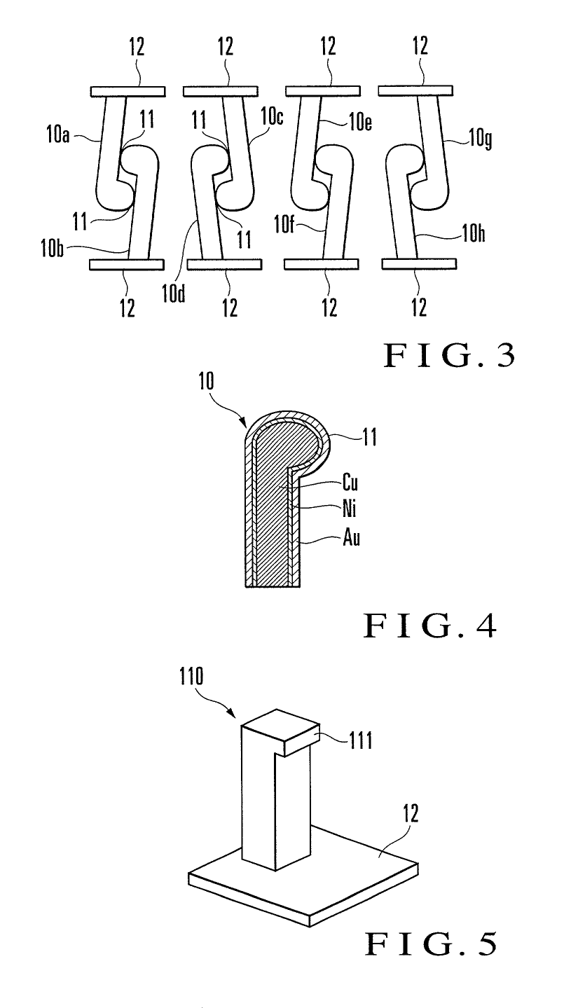

FIG. 3 shows the connected states of the mounting pins shown in FIGS. 1A and 1B. As shown in FIG. 3, a plurality of mounting pins 10a to 10h as connection terminals are formed on respective electrode pads 12 in one-to-one correspondence such that they engage with each other when opposing connection targets are to be connected.

The pair of mounting pins 10a and 10c, and the pair of mounting pins 10e and 10g that are adjacent each other with their locking projections 11 facing each other, and the pair of mounting pins 10c and 10e that are adjacent to each other with their locking projections 11 being set back to back are alternated repeatedly. Similarly, the pair of mounting pins 10d and 10f that are adjacent to each other with their locking projections 11 facing each other, and the pair of mounting pins 10b and 10d and the pair of mounting pins 10f and 10h that are adjacent to each other with their locking projections 11 being set back to back are alternated repeatedly.

In mounting, when the opposing mounting pins 10a and 10b, 10c and 10d, 10e and 10f, and 10g and 10h are aligned with each other and moved close to each other, their pin distal ends come into contact with each other first. After that, the pin distal ends climb over the corresponding locking projections 11 and the locking projections 11 are locked with each other. Thus, the opposing mounting pins engage with each other.

This will be described in detail by way of the mounting pins 10a and 10b. When the mounting pins 10a and 10b as the connection targets are urged against each other, they are pushed out in directions opposite to the projecting directions of their locking projections 11. Therefore, forces that try to restore the mounting pins 10a and 10b to the initial positions in the non-contact state along substantially the vertical direction of the upper surfaces of the electrode pads 12 act on the mounting pins 10a and 10b. As a result, in mounting, the engaged state of the mounting pins 10a and 10b is maintained, and the electrically connected state of the circuit board 13 and LSI 14 is maintained through the electrode pads 12.

The locking projections 11 that lock each other are merely caught by each other at such an angle that they tend to smoothly slip on each other. Therefore, if the locking projections 11 are moved away from each other, the engaged mounting pins can be disengaged easily. In other words, if the locking projections 11 are pulled in a direction opposite to the pushing direction, they can be pulled out from each other easily.

In this manner, in mounting, the mounting pins 10 as the connection targets are engaged, with their locking projections 11 opposing each other, by the reaction forces (restoring forces that try to restore to the initial positions in the non-contact state) accompanying mechanical contact.

In mounting, in the mounting pins 10c and 10d respectively adjacent to the mounting pins 10a and 10b as well, an engaged state similar to that of the mounting pins 10a and 10b is maintained by forces acting in directions opposite to the mounting pins 10a and 10b. This applies to the mounting pins 10e and 10f respectively adjacent to the mounting pins 10c and 10d. The same engaged state is maintained in all of the mounting pins 10 formed on the plurality of electrode pads 12 which are lined up.

FIG. 4 shows the internal structure of a conductive mounting pin of FIG. 1. As shown in FIG. 4, the mounting pin 10 is comprised of three materials, i.e., Cu, Ni, and Au sequentially from the center to the outer surface. The materials of the mounting pin 10 are not limited to these three materials, but the mounting pin 10 may be made of two materials, e.g., Cu and Au, Ni and Au, or the like. As the material of the outer surface, Pt, Ag, Pd, Rh, Ru, or the like may be used in place of Au.

As shown in FIG. 1A, the mounting pin 10 is constituted by a prismatic leg and the locking projection 11 projecting from the distal end of the leg in a direction perpendicular to the leg, to have an inverted L shape. The locking projection 11 is formed into the shape of an arrowhead by narrowing the distal ends of its upper and lower surfaces.

FIG. 5 shows anther example of the mounting pin. As shown in FIG. 5, a mounting pin 110 may be formed by projecting the distal end of its leg sideways to have a rectangular section such that its locking projection 111 forms a rectangular parallelepiped. Alternatively, the leg may be cylindrical, or the locking projection may be formed by flexing an entirely round oval, pyramidal, or cylindrical leg.

More specifically, it suffices if the opposing mounting pins 10 or 110 as the mounting targets have such shapes that their opposing locking projections 11 or 111 lock each other in mounting and removably disengage from each other in removal. The opposing mounting pins 10 or 110 may have the same shape or different shapes.

In the multi-pin, small-pitch, high-density mounted structure, the leg of the mounting pin 10 or 110 is formed such that, e.g., its thickness is about 10 μm and its depth is about 30 μm to 40 μm. In other words, a sufficient depth is assured so the mounting pins 10 or 110 formed on the electrode pads 12 with a pad pitch of about 40 μm to 20 μm reliably mesh with each other even if misalignment occurs during connection where their distal ends lock each other. The projecting length of each locking projection 11 or 111 is about 10 μm.

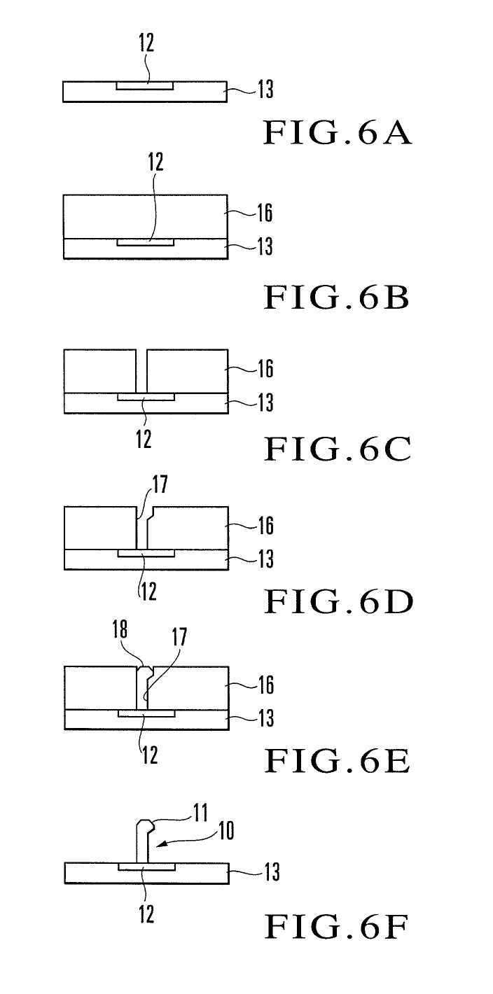

FIGS. 6A to 6F show the steps in manufacturing the mounting pin 10. First, an electrode pad 12 (FIG. 6A) is formed on a circuit board 13. Then, the electrode pad 12 is covered by photolithography, and a photosensitive photoresist 16 is applied to the entire surface of the circuit board 13 (FIG. 6B). By using the first mask (not shown), the photosensitive photoresist 16 is exposed to reach the electrode pad 12, and is developed (FIG. 6C). After development, by using the second mask (not shown) with an opening diameter larger than that of the first mask, only the surface of the photosensitive photoresist 16 is exposed and developed. Hence, a hole 17 having a circular section and two opening diameters, with the diameter of the upper surface being extended in one direction, is formed in the photosensitive resist 17 (FIG. 6D).

The interior of the hole 17 with a step is subjected to electroplating to deposit a metal component 18 (FIG. 6E). The photosensitive photoresist 16 is washed and the resultant surface is plated, thus fabricating the mounting pin 10 made of the metal component 18 on the electrode pad 12. Hence, the mounting pin 10 with a locking projection 11 as an extending portion at its distal end stands upright on the electrode pad 12 in accordance with the shape of the hole 17 (FIG. 6F). In this manner, by utilizing the phenomenon that the metal component 18 deposited by plating naturally swells to form a curved surface free from corners, electroplating is performed twice to form the locking projection 11 at the distal end.

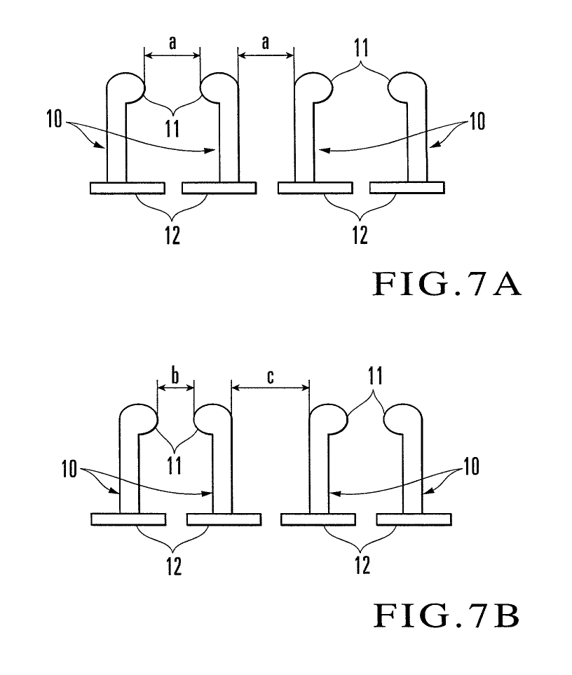

FIGS. 7A and 7B show how the mounting pins 10 are arranged. The mounting pins 10 are formed on the electrode pads 12 arranged at a predetermined interval, such that adjacent intervals a between the locking projections 11 or between the rear surfaces of the locking projections 11 become equal and minimum, as shown in FIG. 7A. In this case, since the electrode pads 12 are arrayed at almost the same intervals, each mounting pin 10 projects from that side of the corresponding electrode pad 12 which is closer to the end than the center. Thus, the adjacent intervals a become equal. When the mounting pin 10 is to be manufactured, photolithography for forming the photosensitive photoresist 16 becomes easy.

As shown in FIG. 7B, when the mounting pins 10 are arranged at the centers of the electrode pads 12, an adjacent interval b between the locking projections 11 becomes smaller than an adjacent interval c between the rear surfaces of the locking projections 11 by the projecting length of the locking projections 11. Therefore, photolithography for forming the photosensitive photoresist 16 becomes difficult to perform. The positions of the mounting pin 10 are determined with reference to the interposer such as a semiconductor chip to be mounted. For this reason, when the positions of the mounting pins 10 are set at the centers of the electrode pads 12, the adjacent interval of the circuit boards 13 corresponding to the small adjacent interval b becomes smaller, making it difficult to form the mounting pins 10.

Furthermore, when the mounting pin 10 is arranged on one side of the electrode pad 12, the force of the electrode pad 12 to stand separation from the circuit board 13 becomes larger than that of a case wherein the mounting pin 10 is located at the center of the electrode pad 12. More specifically, in mounting, the mounting pin 10 is pushed outward, and the electrode pad 12 on which the mounting pin 10 stands upright receives a rotational moment. At this time, the electrode pad 12 is fixed to the circuit board 13 and stands the separating force generated between the electrode pad 12 and the mounting target generated by the rotational moment. As the mounting pin 10 is arranged on one side of the electrode pad 12, the fixed portion of the electrode pad 12 which stands separation can be increased.

With these mounting pins 10, the circuit board 13 and an interposer, e.g., a chip, mounted on the circuit board 13 can be freely detached from and attached to each other. Therefore, in the completed module parts shipping process after mounting, checking and repair of a defective product in accordance with the functional test of the module can be facilitated.

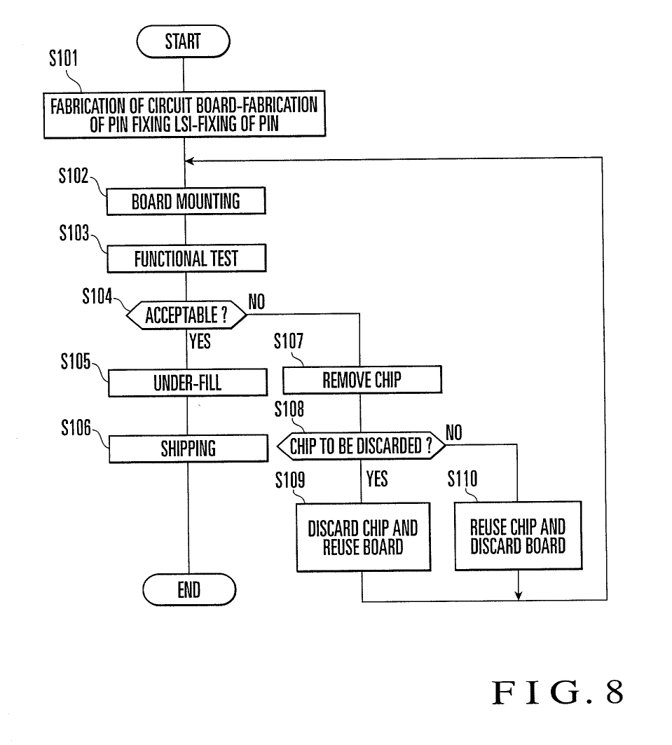

FIG. 8 shows the flow chart of a process for shipping completed module parts mounted by using the mounting pins 10. As shown in FIG. 8, when a completed module is to be shipped, first, fabrication of the circuit board 13 and fixing of the mounting pins 10 to the circuit board 13, and fabrication of the LSI 14 and fixing of the mounting pins 10 to the LSI 14 are performed (step S101). The mounting pins 10 fixed to the LSI 14 are connected by locking to the mounting pins 10 fixed to the circuit board 13, to obtain a board in a mounted state in which a chip is mounted on the circuit board 13 (step S102).

Then, a functional test in the board mounted state is performed (step S103), and it is checked whether the test result is acceptable (step S104). If the check result is acceptable, that is, if the operation of the chip in the mounted state is normal and a target function is obtained, under-fill is performed (step S105), and the product is shipped (step S106).

If the check result is not acceptable, that is, if the operation in the chip in the mounted state is not normal and the target function cannot be obtained, the chip is removed from the circuit board 13 (step S107), and it is checked whether the chip is to be discarded (step S108). If the check result indicates that the chip should be discarded, the removed chip is discarded, and the left circuit board 13 is reused (step S109). The circuit board 13 is reused in board mounting of step S102. In step S108, if the check result indicates that the chip should not be discarded, the circuit board 13 from which the chip has been removed is discarded, and the left chip is reused (step S110). The chip is reused by board mounting of step S102.

In this manner, since the circuit board 13 and the chip or interposer can be freely attached to and detached from each other through the mounting pins 10, when a defective product is found by the test in the temporary assembled state before shipping, it can be removed and replaced with a good one. Therefore, in accordance with the functional test of the mounted module, if the interposer or circuit board 13 is defective, it can be discarded easily; if non-defective, it can be reused easily. Thus, the yield can be greatly increased.

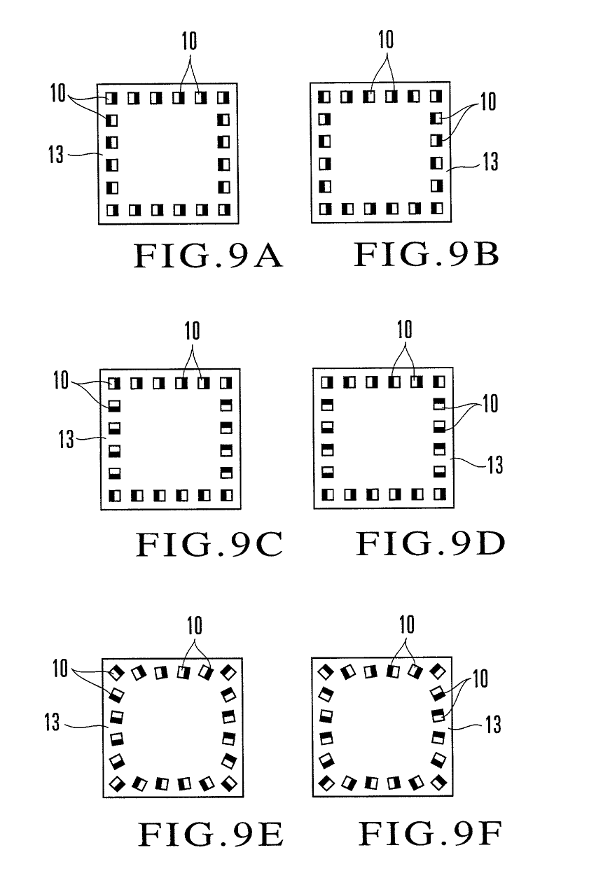

FIGS. 9A to 9F, 10A to 10E, and 11A to 11F show arrangement examples of the mounting pins 10. In the drawings, black portions indicate mounting pins 10 formed on a circuit board 13, and white portions indicate mounting pins 10 formed on a chip or interposer (not shown). The boundaries between the black portions and white portions form meshing lines where locking projections 11 mesh with each other.

The mounting pins 10 shown in FIGS. 9A and 9B are arranged in one line along the edges of the circuit board 13 and interposer to be separated from each other by a distance almost corresponding to the pin width. The locking projections 11 of the mounting pins 10 on two opposing sides face the same direction (FIG. 9A). Alternatively, the locking projections 11 of the adjacent mounting pins 10 face the opposite directions (FIG. 9B), but their meshing lines face the same direction.

Therefore, when the interposer is shifted along the surface of the circuit board 13 in a direction along the meshing lines (vertical direction in FIGS. 9A and 9B), the locking projections 11 can lock with or disengage from each other. In other words, the interposer can be mounted on the circuit board 13 in the locked state or can be removed from it. In this case, since no bent or the like does not substantially occur in the mounting pins 10 due to mounting or removal of the interposer, the mounting pins 10 will not be damaged easily, and the number of times of mounting and removal can be increased.

When the interposer is moved in a direction to be close to or away from the surface of the circuit board 13, that is, in a direction perpendicular to the circuit board 13, the interposer can also be mounted on or removed from the circuit board 13. This applies also to a case wherein the arrangement of the mounting pins 10 on the circuit board 13 and that of the mounting pins 10 on the interposer are opposite.

The mounting pins 10 shown in FIGS. 9C and 9D are arranged in one line along the edges of the circuit board 13 and interposer to be separated from each other by a distance almost corresponding to the pin width, such that the meshing lines of the mounting pins 10 located on adjacent sides are almost perpendicular. Therefore, even when the interposer is shifted along the surface of the circuit board 13, the locking projections 11 cannot lock with or disengage from each other. In other words, the interposer cannot be mounted on or removed from the circuit board 13. The interposer is mounted on or removed from the circuit board 13 by moving it in a direction to be close to or away from the surface of the circuit board 13.

The mounting pins 10 shown in FIGS. 9E and 9F are arranged in one line along the edges of the circuit board 13 and interposer to be separated from each other by a distance almost corresponding to the pin width, such that the meshing lines of the locking projections 11 are radial. The locking projections 11 of the adjacent mounting pins 10 face almost the same direction for each side (FIG. 9E), or the facing direction is reversed for every side (FIG. 9F).

Therefore, even when the interposer is displaced along the surface of the circuit board 13, the locking projections 11 cannot lock with or disengage from each other. The interposer is mounted on or removed by moving it in a direction to be close to or away from the surface of the circuit board 13. In other words, when the mounting pins 10 are arranged radially, the interposer is removed from the circuit board 13 by pulling it from above.

This arrangement can be adopted when the interposer is to be connected to a circuit board 13 made of a material, e.g., a glass-reinforced epoxy resin, a ceramic material, or the like, with a thermal expansion coefficient different from that of silicon. In this case, since a positional error caused by a temperature change is absorbed by the shift of the locking portion serving as the contact, no stress is applied to the locking portion, and a high reliability can be obtained.

In particular, when the mounting pins 10 face almost the same direction for each side and the facing directions are equalized (FIG. 9E), the stress can be canceled by the circuit board 13 as a whole, so no small-pitch portion is formed. When the facing directions is reversed for every side and are not equalized (FIG. 9F), the stress can be canceled for each mounting pin 10.

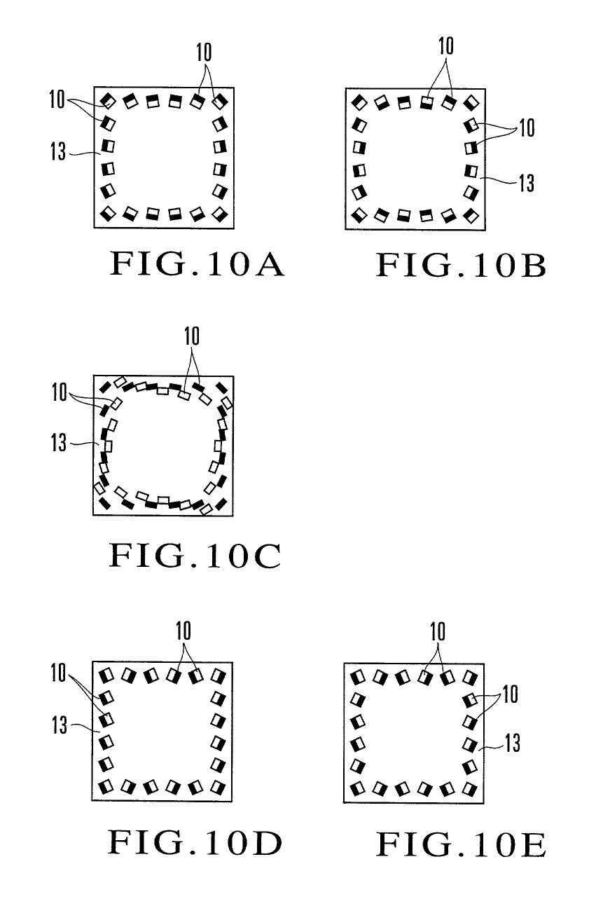

Mounting pins 10 shown in FIGS. 10A and 10B are arranged in one line along the edges of a circuit board 13 and interposer to be separated from each other by a distance almost corresponding to the pin width. Locking projections 11 of the circuit board 13 are located on the outer sides of the locking projections 11 of the interposer (FIG. 10A), or adjacent locking portions are located on the inner and outer sides alternately (FIG. 10B), so the meshing lines of the locking projections 11 draw a circle.

The arrangement shown in FIG. 10A can be adopted when the interposer is to be connected to a circuit board 13 made of a material, e.g., a glass-reinforced epoxy resin, with a thermal expansion coefficient larger than 10 ppm. In this case, the circuit board 13 expands when it is heated to about 200° C. Hence, when the interposer is rotated in a direction along the surface of the circuit board 13 (FIG. 10C), the interposer can be mounted or removed without bending the mounting pins 10 upon mounting or removal operation. In the arrangement shown in FIG. 10B, the interposer can be mounted or removed by rotating it in the same manner.

Mounting pins 10 shown in FIGS. 10D and 10E are arranged in one line on the edges of a circuit board 13 and interposer to be separated from each other by a distance almost corresponding to the pin width. The mounting pins 10 face the same direction while inclining the meshing lines, such that the mounting pins 10 adjacent in a direction along the meshing lines are on the same side (FIG. 10D). Alternatively, the facing directions are partly changed (FIG. 10E).

When the mounting pins 10 are arranged in this manner, the interposer can be mounted or removed without sliding it along the surface of the circuit board 13. If inclination (taper) is added, insertion and removal become easy, and when insertion is to be performed, over-insertion that causes accidental removal does not occur.

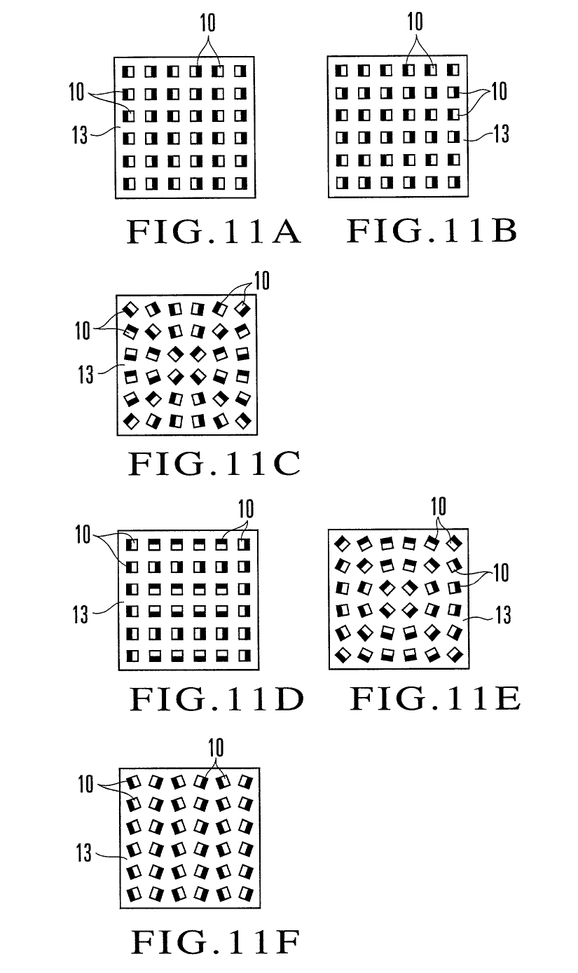

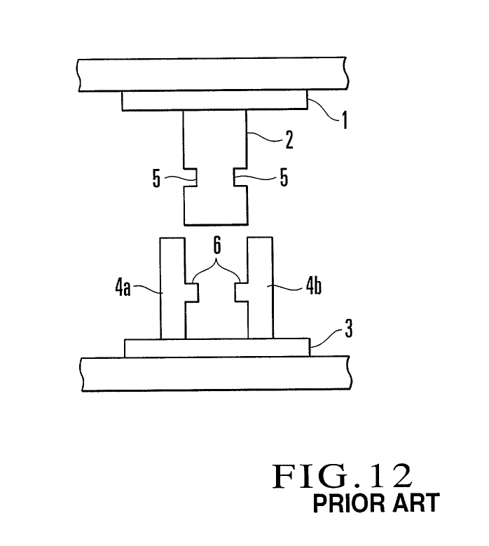

Mounting pins 10 shown in FIGS. 11A and 11B are arranged in a matrix on the entire surfaces of a circuit board 13 and an interposer to be separated from each other by a distance almost corresponding to the pin width. Respective locking projections 11 are arranged vertically and horizontally, such that they face the same direction while reversing the facing direction for each column (FIG. 11A), or such that they face the same direction while reversing the facing direction for each row (FIG. 11B).

Therefore, when the interposer is shifted by sliding it on the surface of the circuit board 13 in a direction along the meshing lines, the locking projections 11 are locked with or unlocked from each other, so the interposer can be mounted on or removed from the circuit board 13. Also, when the interposer is moved in a direction to be close to or away from the surface of the circuit board 13, the interposer can also be mounted on or removed from the circuit board 13.

Mounting pins 10 shown in FIG. 11C are arranged on the entire surfaces of a circuit board 13 and interposer to be separated from each other by a distance almost corresponding to the pin width, while the facing directions of locking projections 11 are different arbitrarily such that the directions of the meshing lines are radial. Hence, when the circuit board 13 and the interposer are made of materials with different thermal expansion coefficients, the locking portion is shifted by a temperature change, so no stress occurs.

Mounting pins 10 shown in FIGS. 11D and 11E are arranged in a matrix on the entire surfaces of a circuit board 13 and interposer such that they are separated from each other by a distance almost corresponding to the pin width. The meshing lines intersect vertically and horizontally (FIG. 11D), or draw a plurality of concentric circles (FIG. 11E). With this arrangement, the interposer can be mounted on or removed from the circuit board 13 by only moving it in a direction to be close to or away from the surface of the circuit board 13.

Mounting pins 10 shown in FIG. 11F are arranged on the entire surfaces of a circuit board 13 and interposer to be separated from each other by a distance almost corresponding to the pin width, such that they face the same direction while inclining the meshing lines. In other words, in the pattern of FIG. 11A, the direction of inclination of the meshing lines is reversed for each column.

With this arrangement, the interposer can be mounted and removed without sliding it along the surface of the circuit board 13. If inclination (taper) is added, insertion and removal become easy, and when insertion is to be performed, over-insertion that causes accidental removal does not occur. In insertion, the deeper the mounting pins are inserted, the more strict the pitch becomes. If the mounting pins are inserted while monitoring, the insertion amount can be adjusted.

In this manner, according to the present invention, fine mounting pins 10 with locking structures are formed by plating on the electrodes of a semiconductor chip with a small-pitch, multi-pin structure. The interposer or the like and the circuit board or the like are connected to each other by a reaction force accompanying mechanical contact.

More specifically, connection is achieved by locking the mounting pins 10 formed on the respective electrode pads 12 of the connection targets with each other. Therefore, the number of pins necessary for this connection can be reduced from three to two, and accordingly the electrode area can accordingly be reduced to about ⅔ the conventional electrode area, thus obtaining a structure suitable for micro-connection. Since each mounting pin 10 is locked by the corresponding mounting pin 10 from one side, a structure that can be easily deformed when being locked and accordingly strong against a stress can be obtained.

The mounting pins 10 can be engaged or disengaged by deformation caused by a temperature change as well as by mechanical deformation. The mounting pins 10 can be formed into various shapes by using various types of materials matching the conditions. Namely, it suffices if the reaction force can be ensured in terms of shape and material. For example, the circuit board 13 and the interposer (attaching chip portion) as the mounting targets may be made of different materials. The circuit board 13 may be formed of a hard material so that it cannot deform easily, and the attaching chip portion may be formed of a soft material so that it can deform easily.

In the above embodiment, the mounting pins 10 have an electrical connecting function. However, the present invention is not limited to this, and the mounting pins 10 may aim at reinforcement regardless of whether they have an electrical connecting function. When the mounting pins 10 do not have an electrical connecting function and aim at reinforcement, they need not be formed on the electrode pads 12. Also, the mounting pins 10 need not be made of a conductive material.

As has been described above, according to the present invention, during mounting, each pair of corresponding mounting pins are connected. This reduces the connection area and is accordingly suitable for a small pitch. This can cope with further increase in packaging density. Also, the manufacturing process is not complicated.

What is claimed is:

1. A mounting pin formed at a pin position on a mounting target and adopted to set the mounting target in a mounted state through pin connection, comprising:
a leg standing upright at the pin position; and
a locking projection formed at a distal end of said leg to project in one direction and capable of locking with a locking projection of another mounting pin through pin connection,
wherein the mounting pins corresponding to each other are set in a pin-connected state by said locking projections when the mounting target is mounted.

2. A pin according to claim 1, wherein said locking projections lock with each other by urging opposing surfaces thereof against each other.

3. A pin according to claim 1, wherein in the pin-connected state, said locking projections are pushed out in directions opposite to projecting directions thereof, thus generating a force that tries to restore said locking projections to initial positions in a non-contact state.

4. A pin according to claim 1, wherein said locking projections that are adjacent are arranged face to face or back to back.

5. A pin according to claim 1, wherein the pin position is shifted toward a rear surface of said locking projection and positioned so that adjacent intervals become equal and minimum.

6. A pin according to claim 1, wherein
said mounting pin further comprises an electrode pad fixed to the mounting target, and
said leg stands upright at the pin position on the electrode pad.

7. A mounting device according to claim 1, comprising
a first mounting target,
a second mounting target to be mounted on said first mounting target, and
a plurality of mounting pins having legs standing upright at pin positions on said first and second mounting targets, and locking projections formed at distal ends of said legs to project in one direction and capable of locking with each other through pin connection,
wherein said mounting pins that correspond to each other are set in a pin-connected state by said locking projections when said first and second mounting targets are mounted.

8. An apparatus according to claim 7, wherein the pin-connected state is canceled by unlocking said locking projections that lock with each other, thereby removing said second mounting target, which has been in a mounted state, from said first mounting target.

9. An apparatus according to claim 7, wherein said mounting pins are arranged in one line along four sides of a rectangle of at least one of said first and second mounting targets to be separated from each other by a distance substantially corresponding to a pin width, such that all meshing lines of said locking projections that lock with each other face the same direction.

10. The apparatus according to claim 7, wherein said mounting pins are arranged in one line along four sides of a rectangle of at least one of said first and second mounting targets to be separated from each other by a distance substantially corresponding to a pin width, such that meshing lines of said locking projections located on adjacent sides are substantially perpendicular.

11. An apparatus according to claim 7, wherein said mounting pins are arranged in one line along four sides of a rectangle of at least one of said first and second mounting targets to be separated from each other by a distance substantially corresponding to a pin width, such that meshing lines of said locking projections that lock with each other are radial.

12. An apparatus according to claim 7, wherein said mounting pins are arranged in one line along four sides of a rectangle of at least one of said first and second mounting targets to be separated from each other by a distance substantially corresponding to a pin width, such that meshing lines of said locking projections that lock with each other draw a circle.

13. An apparatus according to claim 7, wherein said mounting pins are arranged in a matrix on an entire rectangular surface of at least one of said first and second mounting targets to be separated from each other by a distance substantially corresponding to a pin width, such that said locking projections face the same direction while reversing a facing direction for every column.

14. An apparatus according to claim 7, wherein said mounting pins are arranged in a matrix on an entire rectangular surface of at least one of said first and second mounting targets to be separated from each other by a distance substantially corresponding to a pin width, such that said locking projections face the same direction while reversing a facing direction for every row.

15. An apparatus according to claim 7, wherein said mounting pins are arranged on an entire rectangular surface of at least one of said first and second mounting targets to be separated from each other by a distance substantially corresponding to a pin width, such that meshing lines of said locking projections that lock with each other are radial.

16. An apparatus according to claim 7, wherein said mounting pins are arranged on an entire rectangular surface of at least one of said first and second mounting targets to be separated from each other by a distance substantially corresponding to a pin width, such that meshing lines of said locking projections that lock with each other intersect vertically and horizontally.

17. An apparatus according to claim 7, wherein said mounting pins are arranged on an entire rectangular surface of at least one of said first and second mounting targets to be separated from each other by a distance substantially corresponding to a pin width, such that meshing lines of said locking projections that lock with each other draw a plurality of concentric circles.

18. An apparatus according to claim 7, wherein said first mounting target comprises a circuit board and said second mounting target comprises an interposer.

19. A method of manufacturing a mounting pin, comprising the steps of:
forming an electrode pad on a circuit board and applying a photosensitive resist to cover the electrode pad by photolithography,
exposing the photosensitive resist by using a first mask so as to reach the electrode pad, and developing the photosensitive resist,
after development, exposing only a surface of the photosensitive resist by using a second mask with an opening diameter larger than that of the first mask, and developing the exposed surface, thereby forming a hole having two opening diameters, with a diameter of a surface portion thereof being extended in one direction, and
subjecting the hole to electroplating so as to deposit a metal component, and thereafter plating a surface from which the photosensitive resist has been removed, thereby forming a pin main body made of the metal component on the electrode pad.
